(19) United States
(12) Patent Application Publication
(10) Pub. No.: US 2023/0269079 A1
(43) Pub. Date: Aug. 24, 2023

(54) DEVICE AND METHOD FOR SHARING SECRET KEY BASED ON NEURAL NETWORK

(71) Applicant: ELECTRONICS AND TELECOMMUNICATIONS RESEARCH INSTITUTE, Daejeon (KR)

(72) Inventor: Ju Young KIM, Daejeon (KR)

(21) Appl. No.: 18/172,525

(22) Filed: Feb. 22, 2023

(30) Foreign Application Priority Data
Feb. 23, 2022 (KR) 10-2022-0023538

(51) Int. Cl. H04L 9/08; H04L 9/40; G06N 3/08

(52) U.S. Cl. CPC H04L 9/088; H04L 63/0869; G06N 3/08

(57) ABSTRACT

Provided are a device and method for sharing a secret key on the basis of a neural network. The method includes acquiring, by a first device, image information of a host, transmitting the acquired image information of the host to a second device, acquiring image information of a guest from the second device and outputting the image information of the host and the acquired image information of the guest, performing mutual authentication on the basis of the image information of the host and the image information of the guest, extracting coordinates for seed generation from the image information of the host and the image information of the guest on the basis of the mutual authentication, generating seeds on the basis of the extracted coordinates and acquiring a secret key on the basis of the generated seeds, and sharing, by the first device and the second device, the acquired secret key.

### CROSS-REFERENCE TO RELATED APPLICATION

This application claims priority to and the benefit of Korean Patent Application No. 10-2022-0023538, filed on Feb. 23, 2022, the disclosure of which is incorporated herein by reference in its entirety.

### BACKGROUND

### 1. Field of the Invention

The present disclosure relates to a device and method for generating a secret key on the basis of a neural network. Specifically, the present disclosure relates to a device and method for generating an input value using an image as a seed in a neural network-based secret key exchange algorithm.

### 2. Discussion of Related Art

Public key-based cryptographic algorithms according to the related art may be algorithms performed on the basis of complex mathematical calculations based on prime factorization. Here, with the development of quantum computers, cryptographic algorithms based on quantum algorithms may be taken into consideration. However, cryptographic algorithms based on prime factorization may be vulnerable to quantum algorithms. As a specific example, Shor's algorithm may be a quantum algorithm for performing prime factorization in a polynomial time and is an algorithm proposed by Peter Shor. Here, an encryption algorithm may be a problem that cannot be solved by a classic computer on the basis of a method of factorizing a composite number of large prime numbers into prime factors. However, when a prime factorization problem can be solved in a polynomial time on the basis of Shor's algorithm as a quantum algorithm, the security of services based on encryption algorithms may become vulnerable. Accordingly, there is a necessity for a post-quantum cryptography algorithm that is secure against quantum computers.

### SUMMARY OF THE INVENTION

The present disclosure is directed to providing a device and method for generating an input value using an image as a seed in a neural network-based secret key exchange algorithm.

The present disclosure is also directed to providing a device and method for sharing a seed in a neural network-based secret key exchange algorithm and safely sharing data using the seed.

The present disclosure is also directed to providing a device and method for a neural network-based secret key exchange algorithm for addressing a vulnerability of prime factorization-based cryptography algorithms.

According to an aspect of the present disclosure, there is provided a method of sharing a secret key on the basis of a neural network, the method including acquiring, by a first device, image information of a host, transmitting the acquired image information of the host to a second device, acquiring image information of a guest from the second device and outputting the image information of the host and the acquired image information of the guest, performing mutual authentication on the basis of the image information of the host and the image information of the guest, extracting coordinates for seed generation from the image information of the host and the image information of the guest on the basis of the mutual authentication, generating seeds on the basis of the extracted coordinates and acquiring a secret key on the basis of the generated seeds, and sharing, by the first device and the second device, the acquired secret key.

According to another aspect of the present disclosure, there is provided a first device for sharing a secret key on the basis of a neural network, the first device including a memory configured to store data, a transceiver configured to transmit and receive data, and a processor configured to control the memory and the transceiver. The processor acquires image information of a host, transmits the acquired image information of the host to a second device, acquires image information of a guest from the second device, outputs the image information of the host and the acquired image information of the guest, performs mutual authentication on the basis of the image information of the host and the image information of the guest, extracts coordinates for seed generation from the image information of the host and the image information of the guest on the basis of the mutual authentication, generates seeds on the basis of the extracted coordinates and acquires a secret key on the basis of the generated seeds, and shares the acquired secret key with the second device.

The following details may be applied in common.

The first device may be a host device, and the second device may be a guest device.

The first device may further receive at least one of setting information, status information, and report information from the second device.

The setting information may include at least one of parameter information, network setting information, and data sharing setting information required for a neural network cryptography-based secret key exchange algorithm.

When the coordinates for seed generation are extracted from the image information of the host and the image information of the guest on the basis of the mutual authentication, lattices corresponding to the coordinates may be generated from each of the image information of the host and the image information of the guest, and specific lattices may be extracted from the lattices as the coordinates to generate the seeds.

Each of the first device and the second device may include a neural network learning model, and the neural network learning model of the first device and the neural network learning model of the second device may be initialized on the basis of previously shared weight information and after the initialization, may repeat learning on the basis of values previously shared between the first device and the second device so that the neural network learning model of the first device and the neural network learning model of the second device may be synchronized with each other.

The seeds may be applied as input values to the neural network learning model of the first device and the neural network learning model of the second device which are synchronized with each other so that the secret key may be generated.

### BRIEF DESCRIPTION OF THE DRAWINGS

The above and other objects, features and advantages of the present disclosure will become more apparent to those of ordinary skill in the art by describing exemplary embodiments thereof in detail with reference to the accompanying drawings, in which:

FIG. 1 is a block diagram of a host client and a guest client according to an exemplary embodiment of the present disclosure;

FIG. 2 is a diagram illustrating a method of configuring a host client screen and a guest client screen according to an exemplary embodiment of the present disclosure;

FIG. 3 is a diagram illustrating an operation of extracting seeds from a client image according to an exemplary embodiment of the present disclosure;

FIG. 4 is a flowchart illustrating a method of extracting seeds according to an exemplary embodiment of the present disclosure;

FIG. 5 is a flowchart illustrating a method of extracting seeds from an image to generate input values according to an exemplary embodiment of the present disclosure; and

FIG. 6 is a block diagram of a device according to an exemplary embodiment of the present disclosure.

### DETAILED DESCRIPTION OF EXEMPLARY EMBODIMENTS

Hereinafter, exemplary embodiments of the present disclosure will be described in detail with reference to the accompanying drawings so that those of ordinary skill in the art may easily implement the present disclosure. However, the present disclosure may be implemented in a variety of different forms and is not limited to the exemplary embodiments described herein.

In describing the present disclosure, when it is determined that a detailed description of a well-known element or function may obscure the gist of the present disclosure, the detailed description will be omitted. Throughout the drawings, parts irrelevant to description of the present disclosure will be omitted, and like reference numerals refer to like elements.

In this specification, when an element is described as being “connected,” “joined,” or “coupled” to another element, it may be directly connected, joined, or coupled to another element, but still another element may be present therebetween. Also, when an element is described as “including” or “having” another element, the element does not exclude another element and may further include still another element unless specifically described otherwise.

In the present disclosure, terms such as “first,” “second,” etc. may be only used for the purpose of distinguishing one element from another and do not limit the order, importance, etc. of elements unless particularly described. Accordingly, within the scope of the present disclosure, a first element in one embodiment may be referred to as a second element in another embodiment, and similarly, a second element in one embodiment may be referred to as a first element in another embodiment.

In the present disclosure, elements that are distinguished from each other are intended to clearly illustrate each feature, but it does not necessarily mean that the elements are separate. In other words, a plurality of elements may be integrated into one hardware or software unit, or a single element may be distributed into a plurality of hardware or software units. Accordingly, unless otherwise noted, such integrated or distributed embodiments are also included in the scope of the present disclosure.

In the present disclosure, elements described in various embodiments are not necessarily essential elements, and some may be optional elements. Accordingly, embodiments including a subset of elements described in one embodiment are also included in the scope of the present disclosure. Also, embodiments that include other elements in addition to elements described in various embodiments are also included in the scope of the present disclosure.

Advantages and features of the present disclosure and methods of achieving them will become apparent from exemplary embodiments described in detail below with reference to the accompanying drawings. However, the present disclosure is not limited to the following embodiments but may be implemented in a variety of different forms. The embodiments are only provided to make the present disclosure complete and fully convey the scope of the present disclosure to those of ordinary skill in the art.

As alternatives to prime factorization-based cryptography algorithms which are vulnerable to quantum algorithms, there are neural network-based secret key exchange algorithms. Neural network-based secret key exchange algorithms may be a method of generating a secret key using a weight that is synchronized with a weight randomly generated between users using a learning method.

For example, a neural network may be an artificial neural network including artificial neurons or nodes. Here, the artificial neural network may include an input layer, a hidden layer, and an output layer on the basis of machine learning or deep learning and may be a model that acquires a desired value through weight-based learning.

For example, a neural network-based secret key exchange algorithm may acquire a seed from an image and generate an input value from the acquired seed. Here, users may perform mutual learning through the generated input value and synchronize weights through the learning. After that, the secret key may be generated on the basis of the synchronized weights. The generated secret key may be used as a secret key of a symmetric key cryptography algorithm. Also, for example, a neural network-based secret key exchange algorithm may involve generating the same input value between users for weight learning. As an example, the input value is generated in the form of a pseudo-random number, and to obtain the same random number, it is necessary to use the same seed required for random number generation.

Accordingly, to use a neural network-based secret key exchange algorithm, it may be necessary to share a seed between users. As an example, an efficient and safe method of sharing a seed between users will be described below.

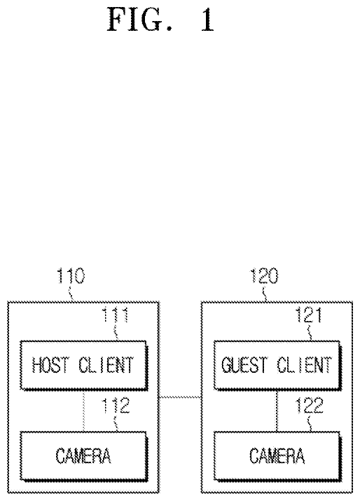

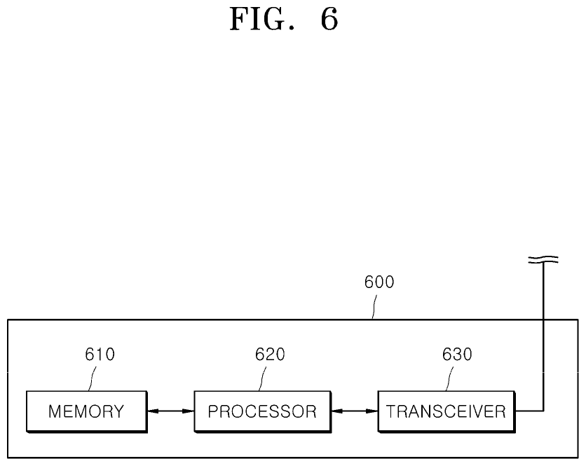

As an example, FIG. 1 is a block diagram of a host client and a guest client according to an exemplary embodiment of the present disclosure. Referring to FIG. 1, the host device 110 may include a host client 111 and a camera 112. As an example, the host device 110 may be a device described below in FIG. 6 and may include a processor, a memory, and a transceiver and perform data transmission and reception on the basis of the processor, the memory, and the transceiver. The host device 110 may include the camera 112 that recognizes a user as the host client 111 and acquires an image of the user. The image of the user acquired through the camera 112 may be transmitted to the guest device 120. Also, the host device 110 may include an output part (not shown), which may be a screen provided to clients on the basis of a video panel. This will be described below.

For example, the guest device 120 may include a guest client 121 and a camera 122. As an example, the guest device 120 may be a device described below in FIG. 6 and may include a processor, a memory, and a transceiver and perform data transmission and reception on the basis of the processor, the memory, and the transceiver. The guest device 120 may include the camera 122 that recognizes a user as the guest client 121 and acquires an image of the user. The image of the user acquired through the camera 122 may be transmitted to the host device 110. Also, the guest device 120 may include an output part (not shown), which may be a screen provided to clients on the basis of a video panel. This will be described below.

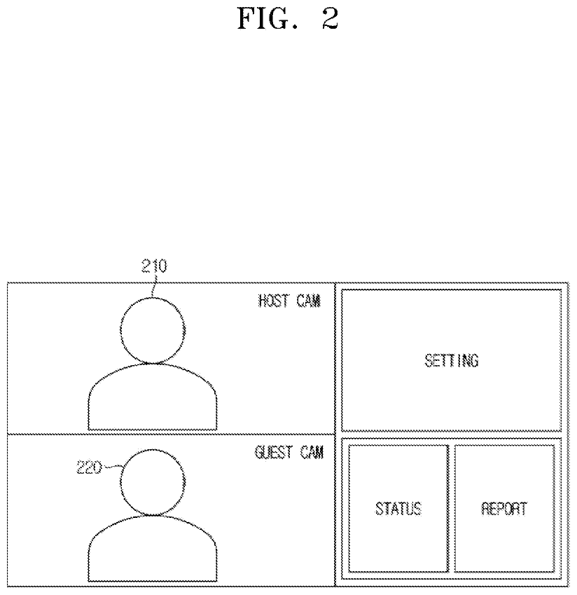

As a specific example, FIG. 2 is a diagram illustrating a method of configuring a host client screen and a guest client screen according to an exemplary embodiment of the present disclosure. Referring to FIG. 2, a client may have a video panel that shows images of a host 210 and a guest 220. In other words, the image of the host 210 as a host device user may be output to a part corresponding to a host camera, and the image of the guest 220 as a guest device user may be output to a part corresponding to a guest camera. Also, for example, setting information may be included in the client screen. Here, the setting information may include a parameter, network setting information, and data sharing setting information required for a neural network cryptography-based secret key exchange algorithm. Further, for example, current status information and report information may be configured as panels in the client screen. The host 210 and the guest 220 may perform mutual recognition and authentication through the panels and perform a neural network-based secret key exchange.

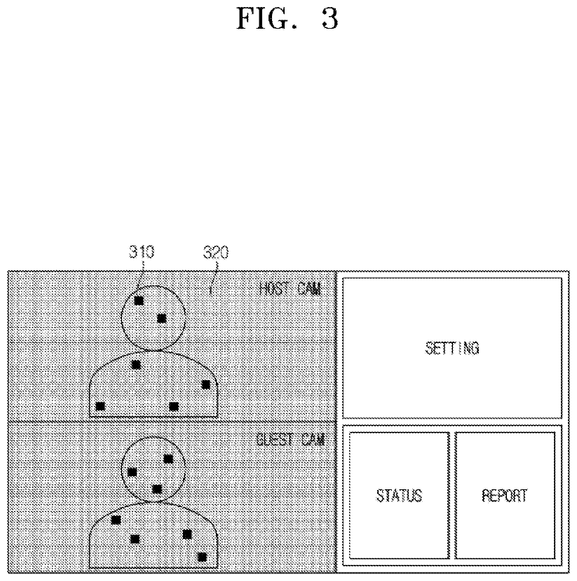

As a specific example, FIG. 3 is a diagram illustrating an operation of extracting seeds from a client image according to an exemplary embodiment of the present disclosure. Referring to FIG. 3, a seed generation procedure may be performed in the video panel. For example, when a seed generation procedure is performed, lattices may be generated in the video panel, and each of the lattices may correspond to extracted coordinate values. For example, in FIG. 3, lattices 310 for seed generation may be extracted on the basis of a host and a guest. On the other hand, lattices 320 which are not extracted may not be used for seed generation.

As a specific example, after a user is authenticated, the authenticated user may be distinguished from a background area, and specific coordinates may be extracted from lattices corresponding to the user as the lattices 310 for seed generation. For example, parts corresponding to the host and the guest may be extracted from images as coordinates, and a background part may not be extracted, but the present disclosure may not be limited thereto. Here, seeds may be generated on the basis of the extracted coordinates, and the generated seeds may be shared to generate a secret key.

Coordinate extraction may be randomly selected after authentication is completed. When an additional input value is necessary even after all input values generated from the seeds acquired from the images are used up, a seed may be additionally generated through random coordinates other than previously generated coordinates.

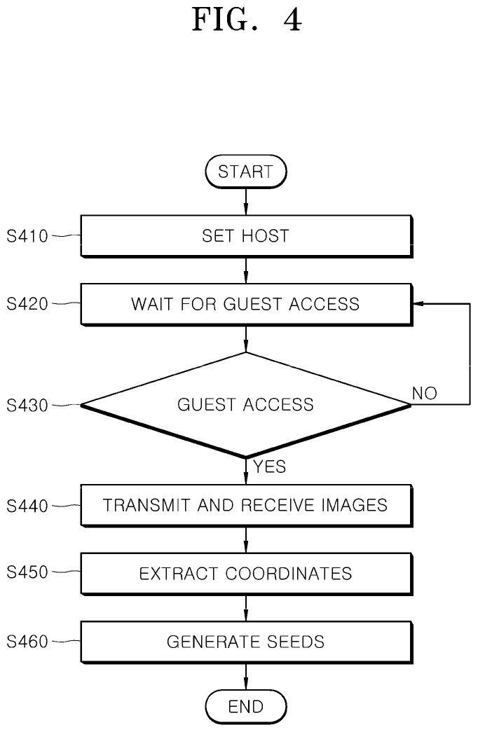

FIG. 4 is a flowchart illustrating a method of extracting seeds according to an exemplary embodiment of the present disclosure. Referring to FIG. 4, as described above, a host device and a guest device may perform mutual authentication through images, generate seeds on the basis of coordinates extracted from the images, and then share the seeds, thereby generating a secret key. For example, a host may be set on the basis of the above description (S410). Here, the host may wait for guest access (S420). When a guest accesses the host (S430), each image of the host and the guest may be transmitted to and received from a corresponding device (S440). As shown in FIG. 2, the transmitted and received images may be configured as a client screen through a video panel in each device, which is the same as described above. After that, the host and the guest may perform mutual authentication on the basis of the transmitted and received images. The host and the guest may identify each other. For example, while performing mutual authentication, the host and the guest may share setting information including a parameter, network setting information, and data sharing setting information required for the neural network cryptography-based secret key exchange algorithm described above with reference to FIG. 2. Also, the host and the guest may provide current status information and report information while performing mutual authentication, which is the same as described above. While performing mutual authentication on the basis of the transmitted and received images, the host and the guest may extract coordinates from the images, which is the same as described above with reference to FIG. 3 (S450). For example, the host and the guest may extract coordinates for seed generation on the basis of coordinates displayed in the images and generate seeds on the basis of the extracted coordinates. After that, the host and the guest may share the generated seed information and generate a secret key using the seed information. In other words, the host and the guest may identify each other through the images and instantly extract seeds in this process. Accordingly, authentication and seed sharing may be simultaneously performed through one communication process. As described above, additional resources are not required for seed generation, and seeds can be generated more efficiently than in a method of using additional seeds according to the related art.

Since the secret key is generated from the generated seeds, the secret key can be recognized only between the host and the guest that perform authentication on the basis of the images, which is different from a public key-based algorithm. Also, the above-described secret key may be generated through neural network-based learning on the basis of the generated seeds. For example, input values and weights of a neural network learning model may be determined on the basis of the generated seeds, and the secret key may be derived by applying the input values and weights to the learning model. In other words, the seed values generated on the basis of image sharing and authentication may be applied to a neural network-based secret key exchange algorithm, and thus the secret key may be generated and shared. In this way, it is possible to improve security.

As a more specific method, a secret key exchange based on neural network synchronization may be performed when each of a host device and a guest device builds a neural network having the same structure. For example, the host device and the guest device may achieve synchronization between the neural networks through a mutual learning process and generate the same secret key using the synchronized neural networks. For example, each of the neural networks of the host device and the guest device may include a two-layer perceptron structure having a plurality of intermediate units and include a tree parity machine (TPM) having an output value of one bit but may not be limited thereto. For example, the host device and the guest device may set and initialize random weights for leaf nodes of the TPMs of the neural networks. The host device and the guest device may set weights independently of each other. After initialization, the host device and the guest device may achieve synchronization between the two neural networks by repeating learning rounds. The same input value disclosed in each learning round may be transferred to the host device and the guest device, and the host device and the guest device may determine parity values of the TPMs of the neural networks. The host device and the guest device may transmit the parity values of their neural networks to each other and compare the parity values of their neural networks with each other, thereby determining whether to update weights included in the TPMs. Here, a method of updating the weights may be a learning rule, which may have various forms and is not limited to a specific form.

For example, a secret key generation method based on neural network synchronization may include an operation in which the host device and the guest device build neural networks, perform neural network synchronization to generate secret keys, and then exchange the secret keys. For example, when the host device and the guest device build neural networks, each of the host device and the guest device may build its own neural network, which is the same as described above. Also, to build TPMs included in the neural networks, the host device and the guest device may determine and share neural network configuration parameters. The neural network configuration parameters may include, but are not limited to, L related to a weight range, h related to the number of intermediate nodes, and n related to the number of leaf nodes connected to the intermediate nodes. After that, the host device and the guest device build TPMs and then assign random weight values to leaf nodes of their own TPMs. The range of weight values may be −L≤weight value≤L. The weight values of the TPMs are only recognizable by the host device and the guest device that assign the weight values. After that, in the case of synchronizing the neural networks, the host device and the guest device may share the learning rule for performing synchronization and repeatedly perform a plurality of rounds on the basis of the learning rule, thereby performing synchronization. Subsequently, the host device and the guest device may generate a secret key. For example, input values for acquiring a secret key on the basis of a neural network may be derived from seeds generated on the basis of the above-described image sharing and authentication, which is the same as described above.

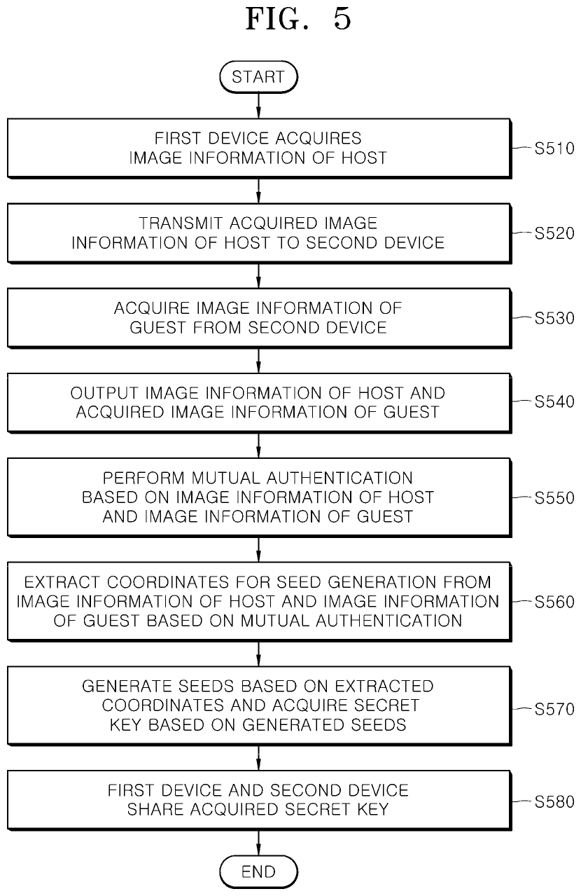

FIG. 5 is a flowchart illustrating a method of extracting seeds from an image to generate input values according to an exemplary embodiment of the present disclosure.

Referring to FIG. 5, a first device may acquire image information of a host (S510). Subsequently, the first device may transmit the acquired image information of the host to a second device (S520) and acquire image information of a guest from the second device (S530). Subsequently, the first device may output the image information of the host and the acquired image information of the guest (S540). Subsequently, the first device and the second device may perform mutual authentication on the basis of the image information of the host and the image information of the guest (S550) and extract coordinates for seed generation from the image information of the host and the image information of the guest on the basis of the mutual authentication (S560). Subsequently, seeds may be generated on the basis of the extracted coordinates, and secret keys may be acquired on the basis of the generated seeds (S570). Subsequently, the first device and the second device may share the acquired secret keys (S580). For example, the first device and the second device may be the above-described host device and guest device, respectively. Also, the first device may further receive at least one of setting information, status information, and report information from the second device. Here, the setting information may include at least one of parameter information, network setting information, and data sharing setting information required for a neural network cryptography-based secret key exchange algorithm. Also, in the case of extracting coordinates for seed generation from the image information of the host and the image information of the guest on the basis of mutual authentication, lattices corresponding to coordinates may be generated from each of the image information of the host and the image information of the guest, and specific lattices may be extracted from the lattices as coordinates to generate seeds. Also, each of the first device and the second device may include a neural network learning model. Here, the neural network learning model of the first device and the neural network learning model of the second device may be initialized on the basis of previously shared weight information. After that, learning may be repeated on the basis of values previously shared between the first device and the second device so that the neural network learning model of the first device and the neural network learning model of the second device may be synchronized with each other. When synchronization is performed, the generated seeds may be applied to the neural network learning model of the first device and the neural network learning model of the second device so that a secret key may be generated. This is the same as described above.

FIG. 6 is a block diagram of a device according to an exemplary embodiment of the present disclosure. As described above, there may be a host device and a guest device. Each of the host device and the guest device may further include at least one of a memory 610, a processor 620, and a transceiver 630 as shown in FIG. 6. For example, with regard to the host device and the guest device, the memory 610 may store information required for neural network-based secret key generation. For example, the memory 610 may store the above-described setting information, status information, and report information and store other information related to a neural network-based secret key algorithm. Also, the processor 620 may control the information stored in the memory 610 on the basis of the above description. The processor 620 may transmit an image acquired through a camera and other information to another device through the transceiver 630 and is not limited to a specific embodiment.

According to the present disclosure, it is possible to provide a device and method for generating an input value using an image as a seed in a neural network-based secret key exchange algorithm.

According to the present disclosure, it is possible to provide a device and method for sharing a seed in a neural network-based secret key exchange algorithm and safely sharing data using the seed.

According to the present disclosure, it is possible to provide a device and method for a neural network-based secret key exchange algorithm for addressing a vulnerability of prime factorization-based cryptography algorithms.

Effects which can be achieved in the present disclosure are not limited to those described above, and other effects which have not been described will be clearly understood by those of ordinary skill in the art from the above description.

To implement a method according to the present disclosure, the illustrative operations may additionally include other operations or exclude some operations and include the remaining operations or additional operations.

Various embodiments of the present disclosure are not intended to be all inclusive and are intended to illustrate representative aspects of the present disclosure. Features described in the various embodiments may be applied independently or in a combination of two or more thereof.

In addition, various embodiments of the present disclosure may be implemented by hardware, firmware, software, or a combination thereof. In the case of hardware implementation, one or more application specific integrated circuits (ASICs), digital signal processors (DSPs), digital signal processing devices (DSPDs), programmable logic devices (PLDs), field programmable gate arrays (FPGAs), general processors, controllers, microcontrollers, microprocessors, etc. may be used for implementation.

The scope of the present disclosure includes software or machine-executable instructions (e.g., an operating system (OS), an application, firmware, a program, etc.) that enable operations according to methods of various embodiments to be performed on a device or computer, and a non-transitory computer-readable medium in which such software or instructions are stored and executable on a device or computer.

What is claimed is:

1. A method of sharing a secret key on the basis of a neural network, the method comprising:
acquiring, by a first device, image information of a host;
transmitting the acquired image information of the host to a second device;
acquiring image information of a guest from the second device and outputting the image information of the host and the acquired image information of the guest;
performing mutual authentication on the basis of the image information of the host and the image information of the guest;
extracting coordinates for seed generation from the image information of the host and the image information of the guest on the basis of the mutual authentication;
generating seeds on the basis of the extracted coordinates and acquiring a secret key on the basis of the generated seeds; and
sharing, by the first device and the second device, the acquired secret key.

2. The method of claim 1, wherein the first device is a host device, and
the second device is a guest device.

3. The method of claim 1, wherein the first device further receives at least one of setting information, status information, and report information from the second device.

4. The method of claim 3, wherein the setting information includes at least one of parameter information, network setting information, and data sharing setting information required for a neural network cryptography-based secret key exchange algorithm.

5. The method of claim 1, wherein, when the coordinates for seed generation are extracted from the image information of the host and the image information of the guest on the basis of the mutual authentication, lattices corresponding to the coordinates are generated from each of the image information of the host and the image information of the guest, and specific lattices are extracted from the lattices as the coordinates to generate the seeds.

6. The method of claim 1, wherein each of the first device and the second device includes a neural network learning model,
the neural network learning model of the first device and the neural network learning model of the second device are initialized on the basis of previously shared weight information, and
after the initialization, the neural network learning model of the first device and the neural network learning model of the second device repeat learning on the basis of values previously shared between the first device and the second device so that the neural network learning model of the first device and the neural network learning model of the second device are synchronized with each other.

7. The method of claim 6, wherein the seeds are applied as input values to the neural network learning model of the first device and the neural network learning model of the second device which are synchronized with each other so that the secret key is generated.

8. A first device for sharing a secret key on the basis of a neural network, the first device comprising:
a memory configured to store data;
a transceiver configured to transmit and receive data; and
a processor configured to control the memory and the transceiver,
wherein the processor acquires image information of a host,
transmits the acquired image information of the host to a second device,
acquires image information of a guest from the second device,
outputs the image information of the host and the acquired image information of the guest,
performs mutual authentication on the basis of the image information of the host and the image information of the guest,
extracts coordinates for seed generation from the image information of the host and the image information of the guest on the basis of the mutual authentication,
generates seeds on the basis of the extracted coordinates and acquires a secret key on the basis of the generated seeds, and
shares the acquired secret key with the second device.

9. The first device of claim 8, wherein the first device is a host device, and
the second device is a guest device.

10. The first device of claim 8, wherein the first device further receives at least one of setting information, status information, and report information from the second device.

11. The first device of claim 10, wherein the setting information includes at least one of parameter information, network setting information, and data sharing setting information required for a neural network cryptography-based secret key exchange algorithm.

12. The first device of claim 8, wherein, when the coordinates for seed generation are extracted from the image information of the host and the image information of the guest on the basis of the mutual authentication, lattices corresponding to the coordinates are generated from each of the image information of the host and the image information of the guest, and specific lattices are extracted from the lattices as the coordinates to generate the seeds.

13. The first device of claim 8, wherein each of the first device and the second device includes a neural network learning model,
the neural network learning model of the first device and the neural network learning model of the second device are initialized on the basis of previously shared weight information, and
after the initialization, the neural network learning model of the first device and the neural network learning model of the second device repeat learning on the basis of values previously shared between the first device and the second device so that the neural network learning model of the first device and the neural network learning model of the second device are synchronized with each other.

14. The first device of claim 13, wherein the seeds are applied as input values to the neural network learning model of the first device and the neural network learning model of the second device which are synchronized with each other so that the secret key is generated.
